(19) United States
(12) Patent Application Publication
(10) Pub. No.: US 2017/0344120 A1
(43) Pub. Date: Nov. 30, 2017

(54) USER-INPUT INTERACTION FOR MOVABLE-PANEL MOBILE DEVICE

(71) Applicant: Intel Corporattion, Santa Clara, CA (US)

(72) Inventors: Joshua L. Zuniga, Damascus, OR (US); Saara Kamppari, Portland, OR (US); David W. Browning, Beaverton, OR (US); Daria A. Loi, Portland, OR (US); Guy M. Therien, Beaverton, OR (US); Aleksander Magi, Aloha, OR (US); Audrey C. Younkin, Hillsboro, OR (US)

(21) Appl. No.: 15/163,399

(22) Filed: May 24, 2016

(51) Int. Cl. G06F 3/01; G06F 1/16; G06F 3/0338

(52) U.S. Cl. CPC G06F 3/017; G06F 3/0338; G06F 1/1649; G06F 1/1652

(57) ABSTRACT

Aspects of the disclosure are directed to processing flex gesturing in a computing device that includes a plurality of display panels movable in relation to one another. Flex movement of a first display panel as detected by at least one flex sensor is assessed. The flex movement is interpreted according to predefined criteria to recognize a flex gesture. In response to the flex gesture, an action to be performed is ascertained from among a plurality of possible actions associated with the flex gesture.

### TECHNICAL FIELD

Embodiments described herein generally relate to information processing and mobile computing and, more particularly, to user-input processing in flexible mobile devices.

### BACKGROUND

Present-day users of mobile devices have become accustomed to the use of various gestures such as swiping and drawing other patterns using the touchscreen interface, as well as tapping, shaking, or other movement of their devices. Still, there remains a need for improving human-machine interaction. For instance, certain types of gestures tend to be more user-intuitive or immersive user experiences, while others are less so. For certain device form-factors, such as tablets and larger-format hand-portable devices, one-handed operation can be challenging if not impossible for users. Moreover, in general, touchscreen interaction with a mobile device tends to obstruct the user's view of the display.

Solutions are needed to provide new and better user-interaction controls for evolving mobile device technology.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a block diagram illustrating some of the components of an example computing device according to an embodiment of the invention.

FIG. 2 is a block diagram illustrating an exemplary system architecture of a computing device such as the device of FIG. 1, according to an embodiment.

FIG. 3 is a diagram illustrating an exemplary hardware and software architecture of a computing device such as the one depicted in FIG. 2, in which various interfaces between hardware components and software components are shown.

FIG. 4A is a diagram illustrating a computing device having a deformable form factor according to an example embodiment in which a single flexible display spans more than one movable panel of the computing device.

FIG. 4B is a diagram illustrating computing device having a deformable form factor according to another example embodiment in which multiple panels each have a their own display device

FIG. 5 is a schematic diagram illustrating a computing device having a greater number of panels, according to an embodiment.

FIG. 6 is a side-view schematic diagram illustrating various examples of postures for a computing device having three panels and two hinges according to some embodiments.

FIG. 7 is a side-view schematic diagram illustrating some examples of gestures using relative motion of the panels according to some embodiments.

FIG. 8 is a high-level block diagram illustrating a system for recognizing panel-movement gestures in a movable-panel computing device according to an embodiment.

FIG. 9 illustrates an example of situational analyzer according to an embodiment, that includes a sensor analyzer engine, and a situational determination engine.

FIG. 10 is a system block diagram illustrating an example architecture of an engine of the sensor analyzer engine of the situational analyzer of FIG. 9.

FIG. 11 is a system block diagram illustrating an example architecture of an engine that forms a part of the situational determination engine of the example depicted in FIG. 9.

FIG. 12 is a system block diagram illustrating an example system architecture of a user interface output engine according to an embodiment.

FIG. 13 is a flow diagram illustrating a set of example processing operations performed by a system, such as the system of FIGS. 8-12, according to various embodiments.

FIG. 14 is an illustrative example of the operations of FIG. 13, where a flexible computing device is being used to display multi-page content, and is operated to input a flex gesture.

### DETAILED DESCRIPTION

Aspects of the embodiments are directed to mobile computing devices having flexible, or folding, displays. Some of the embodiments detailed below describe new features that facilitate user interaction with such devices. Emerging trends of flexible organic light-emitting diode (OLED) displays offer new ways for users to interact with customizable shapes on mobile form factors. Some embodiments facilitate user-device interaction without the need for moving the user's hand when holding a device in a comfortable position (e.g., having to use ones' fingers to pinch and zoom or interact with graphical user interface (GUI) controls). Related embodiments are directed to creating more efficient and speedier interaction when manipulating, editing, creating or reviewing content.

Related embodiments configure a mobile device to respond to gestures based on flexing or pivoting portions of the screen. Advantageously, some embodiments described below provide a way for a user to interact with digital content on their mobile device without having to obstruct their view of content due to their use of an input device or finger; thereby optimizing screen viewability and input. Related embodiments facilitate intuitive gesturing by manipulation of the pivotable or flexible screen taking into account the usage context, including such factors as the posture of the device, the orientation of the device, additional user inputs to the device, the control criteria of application(s) running on the device, or any default control behavior of the operating system running on the device.

A mobile device may take any of a variety of device types. For instance, it may be a multi-functional device such as a smartphone, tablet, laptop, smartwatch, wearable form factor (e.g., smart glasses or a device embedded in garment), etc. A computing device may have a variety of integrated data capture devices, or may be interfaced with a distinctly-housed data capture device.

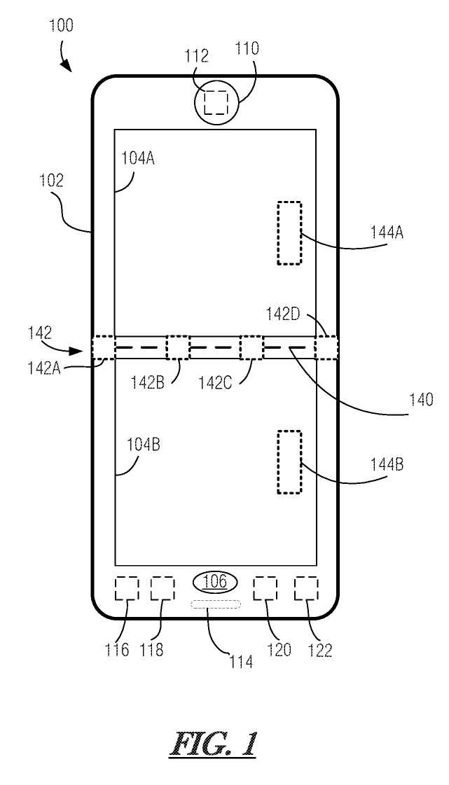

FIG. 1 is a block diagram illustrating some of the components of an example computing device 100 according to an embodiment. Computing device 100 is illustrated as a smartphone in this example, through it will be understood that computing device 100 is representative of other types of computing devices, which may have more or fewer data capture devices or other features than exemplary computing device 100. Computing device 100 has a housing 102 that encloses the interior components. Housing 102 may provide access to the interior of device 100 to some degree. For instance, in devices with a user-replaceable battery, flash memory card, or subscriber identity engine (SIM) card, housing 102 may include a user-removable cover. In devices having a design that does not facilitate user access to the interior, housing 102 may nonetheless have a provision for permitting access to technicians so that certain components may be repaired or replaced if needed. In some embodiments, housing 102 includes multiple connected panels that are independently movable with respect to one another to some extent. For example, the panels may be hinged, as will be described in greater detail below.

Computing device 100 further includes one or more display screens 104A, 104B (collectively referred to as displays 104) that are incorporated into independently-movable panels of housing 102 of computing device 100. Displays 104 may also be portions of one single flexible display, such as an FOLED display, for instance. Displays 104 include hardware that functions as an output device (e.g., an organic light-emitting diode OLED screen for visual display, power and controller circuitry, etc.). In a related embodiment, displays 104 include a touchscreen input device generally layered over (or under) the visual display and formed from a suitable touch or proximity-sensitive technology (e.g., capacitive, resistive, optical, ultrasonic, etc.), along with the corresponding detection and power circuitry.

In one type of embodiment, computing device 100 includes at least one hinge 140 that joins panels of housing 102 while permitting relative motion about an axis of rotation. Hinge 140 may be realized by any suitable mechanism including, for example, a flexure bearing, such as a poly hinge formed from a deformable material such as an elastomer, e.g., silicone-based, natural or synthetic rubber-based, flexible thermoplastic, or the like. A flexure bearing hinge may also be formed as a living hinge using the same material as the housing 102, albeit with slots, perforations reduced material thickness, or other provision to facilitate flexing of the hinge. In other embodiments, hinge 140 may include a mechanism formed or constructed from rigid bodies, such as a barrel hinge, a pivot hinge, a mortised hinge, a piano hinge, a butterfly hinge, a flag hinge, a strap hinge, an H-hinge, a tee hinge, or any other suitable mechanism. In an embodiment, hinge 140 is situated between two or more panels, each having displays 104 of computing device 100, such that the displays 104 are pivotally rotatable relative to one another. For example, hinge 140 may facilitate folding and un-folding of computing device 100 in book-like fashion.

Additionally, computing device 100 includes user input device 106, which in this example represents one or more user-operable input devices, such as button(s), keypad, keyboard, trackpad, mouse, etc.

As further depicted in FIG. 1, computing device 100 has several data capture devices, such as sensing transducers, the physical stimulation of which produces signaling that may be sampled, digitized, and stored as captured data. Camera 110 includes an image sensor 112, along with additional hardware for digitizing, processing, and storing portions of the image sensor 112 output. Camera 110 also includes optics that may form a portion of housing 102. Camera 110 may record still images, motion video, or both.

Microphone 114 includes audio capture circuitry that samples, digitizes, and stores portions of the signaling produced by microphone 114 in response to sensed acoustic stimulus. Microphone 114 is typically activated together with camera 110 when data capture device 100 is operated to record videos.

Global positioning system (GPS) receiver 116 includes an antenna and radio receiver circuitry to receive multiple signals being broadcast by a constellation of Earth-orbiting satellites, along with processing circuitry to discern the current position on the Earth of data computing device 100. Accelerometer 118 includes a multi-axis sensor that produces signaling in response to changes in motion, and electronics to sample and digitize that signaling. Magnetometer 120 includes sensors and supporting circuitry that detect the direction and intensity of the ambient magnetic field, or any externally-applied magnetic fields. Biometric sensor 122 includes an array of sensors for measuring a biometric indicator, such as a user's fingerprint, along with supporting circuitry.

The various data capture devices, whether individually, or in combination with one or more other data capture devices, may obtain information from which computing device 100 may discern facts about its operational state(s) or surrounding environment. For example, accelerometer 118 and magnetometer 120 may be used in combination to determine the orientation of computing device 100 with greater accuracy than either of these data capture devices alone.

In embodiments having hinge 140, a set of one or more hinge status sensors 142 may be provided. In a related embodiment, an array of hinge status sensors 142A-142D is situated along hinge 140. According to various embodiments, each one of hinge status sensor 142 is constructed, or otherwise configured, to detect the position, or movement, of hinge 140. In an embodiment where the position of the hinge 140 is sensed, movement (e.g., rate of rotation) of hinge 140 may be computationally determined from the rate of change of the sensed position. Likewise, in an embodiment where the movement of hinge 140 is sensed, the position of hinge 140 may be computationally determined from the sensed motion, relative to an initial position. In a related embodiment, both, position and motion, may be sensed, and combined, from which an accurate assessment of the state of the hinge may be determined.

Hinge sensor 142 may utilize any one, or a combination of, suitable sensing technologies including, for example, piezoelectric strain sensing, accelerometer(s) or gyroscope(s), proximity sensing (e.g., magnetic-field, capacitance, etc.), an optical sensing (e.g., transmission/obstruction, Doppler, inferometry, etc.). Hinge sensor 142 may be situated at the hinge itself, or in one or more of the hinged panels.

In a related embodiment, each panel containing a display 104 includes a respective one or more deformation sensor 144A, 144B that is constructed, or otherwise configured, to detect flexing or bending of the panel along one or more axes of deformation. Deformation sensors 144A, 144B may use any suitable sensing technology (e.g., any of those listed in the examples above for hinge sensor 142), and may employ a similar or different sensing principle or arrangement with respect to hinge sensor 142. In a related embodiment deformation sensor 144

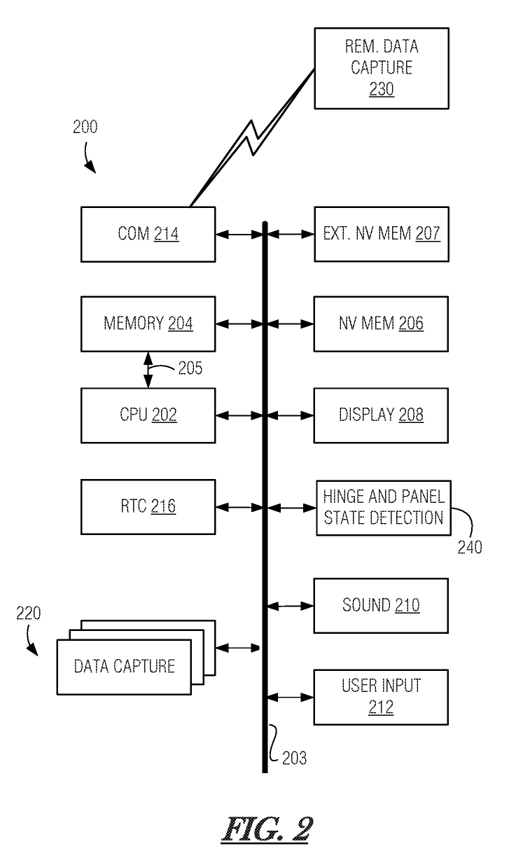

FIG. 2 is a block diagram illustrating an exemplary system architecture 200 of computing device 100 according to an embodiment. Central processor unit (CPU) 202 includes one or more microprocessors on which the overall functionality of computing device 100 is executed. CPU 202 is formed from hardware that is electrically interfaced with system link 203, which carries data and control signaling between the various components. As illustrated, system link 203 is similarly interfaced with each of the other components of system architecture 200. Memory 204 includes working memory space, and is constructed from suitable high-speed memory devices such as synchronous dynamic random access memory (SDRAM). In the embodiment illustrated, CPU 202 may access memory 204 using high-speed interface 205. Non-volatile memory 206 is constructed using read-only memory (ROM), electrically-erasable programmable read-only memory (EEPROM), flash memory or other suitable non-volatile storage technology. Non-volatile memory 206 stores system and application software that is executed by CPU 202 and, in some cases, by processors present in one or more other components.

External non-volatile memory 207 includes an interface such as a secure digital (SD) card slot, which may accept removable storage media to be used as additional non-volatile data storage.

Display 208 includes display 104 and circuitry for interfacing the display 104 with the system, as well as video driving circuitry. Sound 210 contains circuitry for driving the audio output to a speaker or headphones, and the circuitry for interfacing with the system. User input 212 contains the circuitry for interfacing with input devices such as input device 106. Communications block 214 represents communications circuitry and circuitry for interfacing the communications circuitry with the system. Communications block 214 may include a radio for communicating over a cellular network such as a network designed according to the Long-Term Evolution (LTE), LTE-Advanced, 5G or Global System for Mobile Communications (GSM) families of standards. Also, communications circuitry 214 may include a Wi-Fi communications radio according to the IEEE 801.11 family of standards, or a Bluetooth radio circuit according to the IEEE 802.15 family of standards. Real-time clock 216 includes circuitry that provides a clock that maintains the current date and time, and that interfaces the clock to the system.

Data capture devices 220 are integrated with computing device 200. According to various embodiments, data capture devices 220 include a plurality of different types of sensing transducers and their associated processing and interface circuitry, such as a camera, GPS, accelerometer, and biometric sensor.

In the case of a camera, the transducer may be an image sensor device, such as a charge-coupled device (CCD) array or a complementary metal-oxide semiconductor (CMOS)-based sensor. In the case of a GPS, the transducer is one or more GPS signal-receiving antennas. In the case of an accelerometer, the transducer may be a micro electro-mechanical system (MEMS)-based device utilizing capacitive, piezoelectric, or other suitable technology to produce electrical signaling. In the case of a biometric sensor, the transducer may be any suitable optical, capacitive, ultrasonic, chemical, or other sensor. It will be understood that these examples are provided herein for illustration and context, and are not meant to be limiting unless expressly enumerated in a particular claim.

The processing circuitry associated with each corresponding transducer may include amplification, buffering, filtering, or other signal-conditioning circuitry to receive the raw analog signal from the corresponding transducer and prepare the analog signaling for digitization, analog-to-digital conversion circuitry to perform sampling, quantization, and digital encoding, and, in some cases, further processing to produce a digital signal representing the physical phenomenon being measured by the transducer in a form that is readable by CPU 202.

Remote data capture device 230 is interfaced with CPU 202 via communication block 214, as depicted. Remote data capture device 230 may be any type of data capture device described above, or may be a different type of data capture device altogether.

Hinge and panel state detection devices 240 are integrated with computing device 200. According to various embodiments, hinge and panel state detection devices 240 include sensing transducers and their associated processing and interface circuitry, for reading the position of one or more hinges (such as hinge 140, for instance), and for measuring the bending, stretching, or other deformation of the corresponding panel.

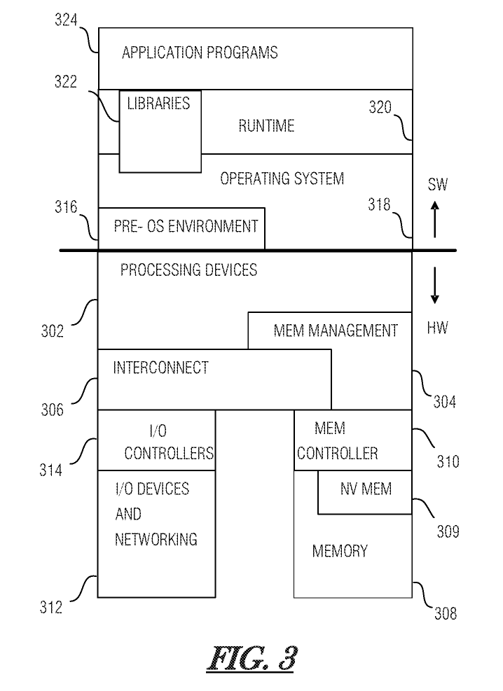

FIG. 3 is a diagram illustrating an exemplary hardware and software architecture of a general-purpose computing device on which various aspects of the embodiments may be realized. The general-purpose computing device may be transformed into a special-purpose machine by instructions that, when executed, cause the general-purpose computing device to carry out operations in accordance with one or more embodiments of the invention. In FIG. 3, various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (i.e., electrically-erasable read-only memory—EEPROM, NAND Flash, NOR Flash, etc.) are interfaced with memory management device 304 and interconnect 306 via memory controller 310. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, described in greater detail below, is responsible for initiating the launching of the operating system, but also provides an execution environment for embedded applications according to certain aspects of the invention. Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) that facilitates interaction with the user via peripheral devices such as a monitor, keyboard, mouse, microphone, video camera, display, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

Examples, as described herein, may include, or may operate on, logic or a number of circuits, components, modules, or engines, which for the sake of consistency are termed engines, although it will be understood that these terms may be used interchangeably. Engines are tangible entities capable of performing specified operations and may be configured or arranged in a certain manner. Engines may be realized as hardware circuitry, as well one or more processors programmed via software or firmware (which may be stored in a data storage device interfaced with the one or more processors), in order to carry out the operations described herein. In this type of configuration, an engine includes both, the software, and the hardware (e.g., circuitry) components. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. With reference to FIG. 3, for instance, an engine may include one, or any combination, of the blocks depicted, so long as at least one block from the HW side is included.

Considering examples in which engines are temporarily configured, each of the engines need not be instantiated at any one moment in time. For example, where the engines comprise a general-purpose hardware processor configured using software; the general-purpose hardware processor may be configured as respective different engines at different times. Software may accordingly configure a hardware processor, for example, to constitute a particular engine at one instance of time and to constitute a different engine at a different instance of time. In view of the above definition, engines are structural entities that have both, a physical structure, and an algorithmic structure. According to some embodiments, engines may constitute the structural means for performing certain algorithmic functions described herein.

A computing platform according to embodiments of the invention is a special-purpose machine that may be configured based on a general-purpose computing device, such as a personal computer (PC) having an architecture such as the one described in the example of FIG. 3. The computing platform may be one physical machine, or may be distributed among multiple physical machines, such as by role or function, or by process thread in the case of a cloud computing distributed model. In various embodiments, aspects of the embodiments may be configured to run in virtual machines that in turn are executed on one or more physical machines. It will be understood by persons of skill in the art that features of the invention may be realized by a variety of different suitable machine implementations.

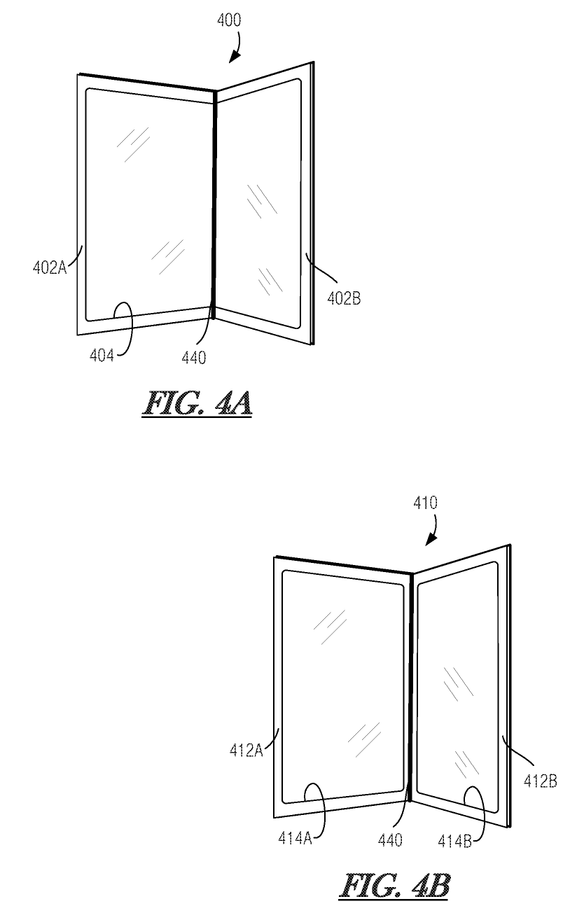

FIG. 4A is a diagram illustrating a computing device 400 having a deformable form factor according to an example embodiment in which a single flexible display spans more than one movable panel of the computing device. In general, computing device 400 may have all, or a subset, of features described above with reference to FIGS. 1-3. Computing device 400 is a hand-portable device that includes two panels, panel 402A and panel 402B, that are pivotally coupled with one another via hinge 440. Hinge 440 may be any suitable type of hinge, such as those described above with reference to FIG. 1. In a related embodiment, panels 402A and 402B are flexible, having some elastic properties. Computing device 400 also includes a set of sensors, and associated circuitry, for measuring the position, motion, or both, of hinge 440 and, where applicable, sensors and associated circuitry for measuring any elastic deformation of panels 402A, 402B. Computing device 400 includes flexible display 404, such as a FOLED display assembled over panels 402A and 402B. In this example, flexible display 404 may be a single, contiguous, display device that spans panels 402A and 402B.

FIG. 4B is a diagram illustrating computing device 410 having a deformable form factor according to another example embodiment in which multiple panels each have a their own display device. In general, computing device 410 is similar to computing device 400, and includes panels 412A and 412B, as well as hinge 440 that pivotally couples the panels to one another. Computing device 410 differs from computing device 400 in that computing device 410 includes a display on each of the panels. As depicted in this example, display 414A is incorporated on panel 412A, and display 414B is incorporated on panel 412B. Displays 414A, 414B and panels 412A, 412B may be flexible or rigid according to various embodiments. In a related embodiment, computing device 410 includes video circuitry and display drivers that treat the multiple displays 414A, 414B as a single screen that extends across panels 412A, 412B. In a related embodiment, each display 414A, 414B is individually controllable, and may be used for duplicating the displayed content of the other display 414B, 414A in such applications as presentations of content to a person at a different vantage point, or providing an obstruction-free touchscreen that is separate from the main display, for example. In some embodiments, the operation of hinge 440 allows panels 412A and 412B to be folded flat against one another.

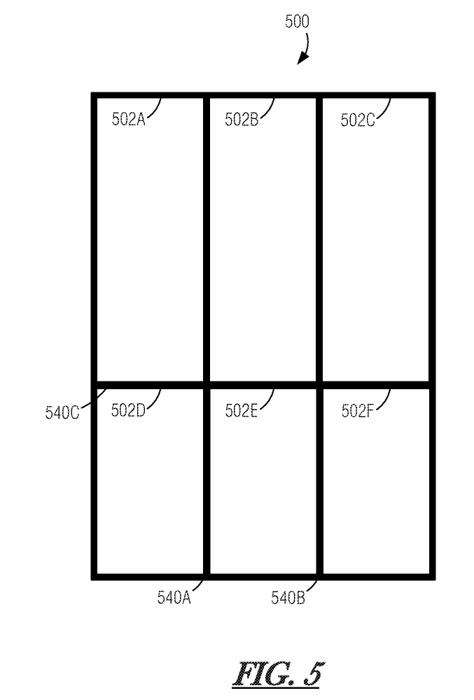

FIG. 5 is a schematic diagram illustrating a computing device 500 having a greater number of panels, according to an embodiment. In general, computing device 500 may have all, or a subset, of features described above with reference to FIGS. 1-4B. Panels 502A-502F are interconnected as illustrated with hinges 540A, 540B, and 540C. Notably, hinge 540C is perpendicular to hinges 540A and 540B. As such, in this embodiment, operation of hinge 540A results in movement of panels 502A and 502D relative to panels 502B and 502E. Similarly, operation of hinge 540B results in movement of panels 502C and 502F relative to panels 502B and 502E. Operation of hinge 540C results in movement of panels 502A, 502B, and 502C relative to panels 502D, 502E, and 502F. In various embodiments, there may be fewer displays than panels by virtue of one or more flexible displays spanning more than one panel. In other embodiments, there may be one or more displays on each panel. Notably, the panels themselves may be flexible to some extent.

One aspect of the embodiments is directed to facilitating user input to a hand-portable computing device based on relative motion of the panels. (e.g., by operation of hinges or elastic deformation of the panels themselves, or both). Related embodiments are based on the recognition that in different use contexts, the various user-input actions may have different intuitive meanings for the user; accordingly, different responses may be called for otherwise similar panel-movement actions.

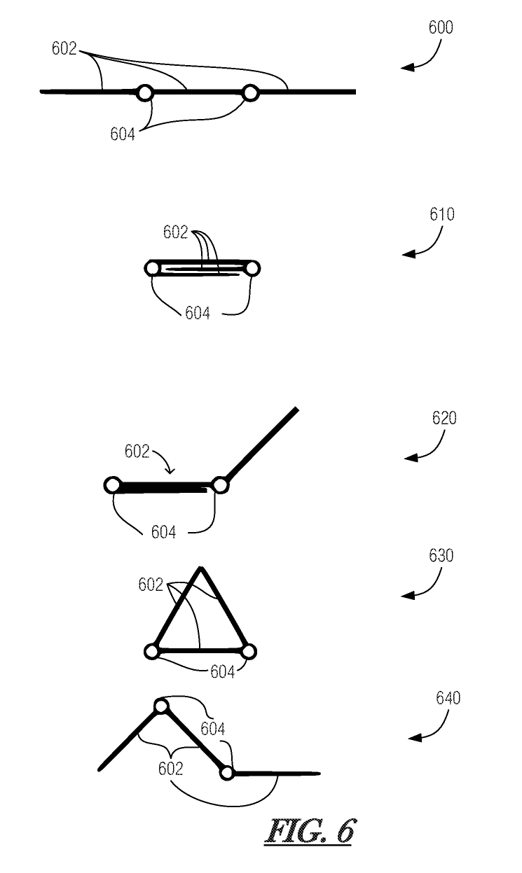

One of the factors affecting the use context is the posture of the computing device. In the present context, the posture refers to the current nominal, or baseline, arrangement of the panels of a hinged multi-panel computing device. FIG. 6 is a side-view schematic diagram illustrating various examples of postures for a computing device having three panels 602 and two hinges 604 according to some embodiments. In the open posture depicted at 600, the mobile device is held, or laid, such that all of the panels are viewable from the same vantage point. The posture indicated at 610 is a closed, screen-out posture in which one panel 602 of the display is visible from the user's perspective, with the other panels being folded over into a compact arrangement.

Posture 620 is a book posture in which two panels 602 are open to the user for viewing or interaction, and the third panel 602 folded over. Posture 630 is a pyramid, or tent, posture in which two panels 602 are viewable from opposite sides, with the third panel 602 situated at a base position and non-viewable. Posture 640 is a propped-up posture in which two panels 602 are viewable from opposite sides, with the third panel 602 accessible from one of the two sides. A variety of other postures are contemplated for 2-panel, 3-panel, and 4+ panel devices. For instance, a column posture that is based on pyramid posture 630 standing on its side with the three panels facing outward, a table, or pi-shaped posture, a waterfall posture, a reverse-tent posture, and the like, may be utilized.

In a related embodiment, the computing device is equipped with sensors and decision logic that configures the device to discern its current posture. In another related embodiment, the posture of the computing device is a factor in the device automatically assessing the use context of the device. In turn, actions responsive to various gestures made by operation of a hinge may be based on the use context.

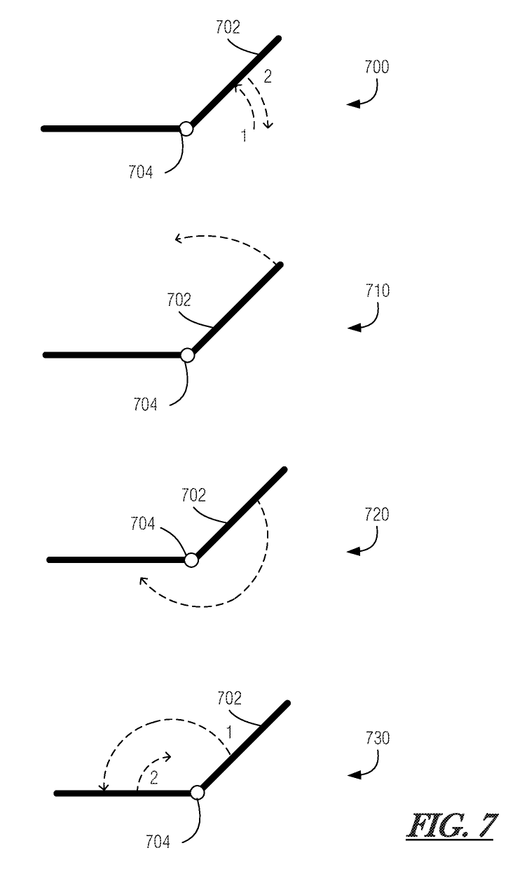

FIG. 7 is a side-view schematic diagram illustrating some examples of gestures using relative motion of the panels according to some embodiments. As illustrated, panel 702 is pivoted by operation of hinge 704. Gesture 700 is a flip gesture in which panel 702 is first partially folded inward from an initial position, then immediately (e.g., within a defined short time window such as one-half second, for instance) returned to the initial position. In some use cases, flip gesture 700 may be interpreted as a command to advance a document or book to the next page, advance a current media item of a playlist to the next media item, and the like. In a related embodiment, a condition relating to the rate of motion of panel 702 in one or both directions is imposed for a gesture to be recognized as flip gesture 700. For example, the angular velocity of the inward-folding or return movements may need to meet or exceed a defined angular velocity to qualify as valid flip gesture 700 movements.

Gesture 710 is a pour gesture in which panel 702 is partially folded inward from an initial position, and maintained in the inward-folded position for at least a predefined time duration, such as one second, for example. In some use cases, pour gesture 710 is interpreted as a command to apply some gradually-variable filter or control adjustment, that may be applied in varying degrees. For instance, pour gesture 710 may be used to apply an image-editing control or filter, with the duration of the inward-folded position of panel 702 corresponding to a gradually increasing application of the control or filter while the pour gesture is invoked. Similar action may be used to control media playback volume, playback speed, or any other controllable parameter that may conventionally be controllable using up/down buttons or a slider GUI control element.

Gesture 720 is a fold gesture in which panel 702 is pivoted so that the display faces outward while the back side of panel 702 is positioned against another one of the panels, and maintained in that position for at least a predefined time duration, such as one second, for example. In one type of embodiment, gesture 720 is interpreted as a transition to an increased touchscreen-interactive mode of operation. In an example of this embodiment, in response to recognition of gesture 720, the computing device changes the display on panel 702 to reveal additional touchscreen controls, such as a tool palate, soft keyboard, handwriting area, etc. In another embodiment, gesture 720 is interpreted as a transition from multi-panel display of information to single-panel display of the information. Accordingly, in an example of this embodiment, the size of the displayed information is changed.

Gesture 730 is a stamp gesture in which panel 702 is pivoted from an initial position toward another panel with the displays facing one another until the displays contact one another or are within some defined close proximity (e.g., 1 cm), then panel 702 is pivoted back towards its initial position. Some embodiments may define a minimum or maximum time duration, or both, during which panel 702 is to remain in contact or close proximity to the other facing panel in order for the gesture to be recognized a stamp gesture 730. In one embodiment, stamp gesture 730 is interpreted as a command to incorporate a feature or parameter from one GUI element displayed on panel 702 to the other panel. For instance, stamp gesture 730 may be used to combine a first phone call or video conference displayed on one panel, with a second phone call or video conference displayed on another panel. Stamp gesture 730 may also be used to perform a paste operation. In a related embodiment, stamp gesture 730 may be used to attach files or other objects to email or multimedia messaging service (MMS) messages.

The illustrative examples discussed above with reference to FIG. 7 are only some examples of a variety of contemplated gestures that may be expressed by motion or flexing of one or more panels, such as panel 702. A greater set of differentiable gestures in a hinged-panel mobile device includes, without limitation, rotate, flip, stamp, pour, nudge, hang, fold, twitch, tap, slide, pull, twist, squeeze, flap, snap, whip, catapult, reveal, turn, shut, open, peek, fan, swipe, pinch, tip, tilt, carry, attach, lean, drop, scan, shake, vortex, brush, bop, knock, pat, rub/stroke, or pull/push (e.g., as a lever).

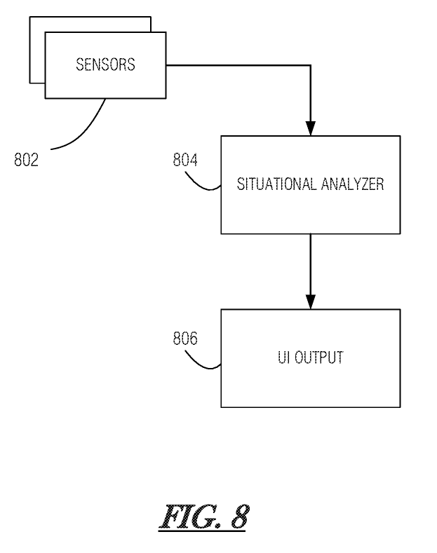

FIG. 8 is a high-level block diagram illustrating a system for recognizing panel-movement gestures in a movable-panel computing device according to an embodiment. As depicted, the system includes sensors 802, situational analyzer 804, and user interface (UI) output engine 806. Sensors 802 may include one or more hinge-position sensors, one or more hinge-motion sensors, one or more panel-flex sensors in each panel, one or more panel motion/acceleration sensors in each panel, and the like. Sensors 802 may also include device motion and orientation sensors, as well as user-input devices such as touchscreen input devices, microphone, camera, and the like.

Situational analyzer 804 is constructed, programmed, or otherwise configured, to read and interpret sensors 802, and to perform situational determinations relating to actions or situations such as the flex gesturing, posture of the computing device, and general usage experience circumstances. UI output engine 806 is constructed, programmed, or otherwise configured, to determine the command, or action to be performed, in response to the flex gesturing. This determination may be based not only on a given flex gesture, but also on the current posture of the computing device, or on the current usage experience. Thus, a given flex gesture may produce different actions, depending on the other circumstances surrounding the flex gesture.

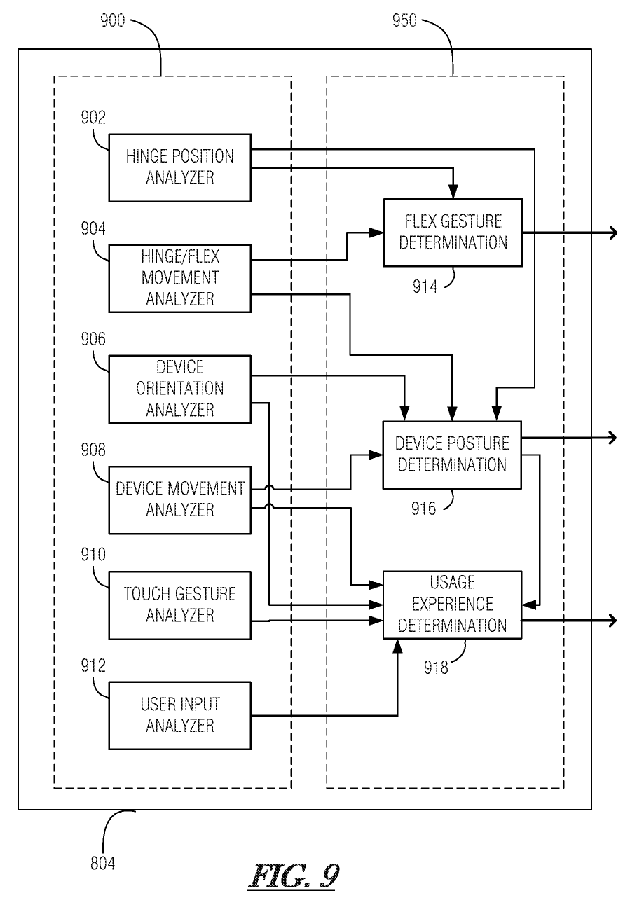

FIG. 9 illustrates an example of situational analyzer 804 according to an embodiment. Situational analyzer 804 includes sensor analyzer engine 900, and situational determination engine 950. Sensor analyzer 900 comprises engines to read, and interpret, sensors 802. In the example depicted, hinge position analyzer 902 reads one or more sensors that are configured to measure the position of one or more hinges that interface respective groups (e.g., pairs) of panels. Hinge/flex movement analyzer 904 measures movement of the hinge(s), which may be represented as a rate of change of the position of those hinge(s), or it may be sensed directly, as by a strain sensor's deflection, accelerometer measurement, or the like. Hinge/flex movement analyzer 904 may also measure the flex, or elastic deflection, of one or more flexible panels. In various embodiments, hinge position analyzer 902 and hinge/flex movement analyzer 904 may each use input from more than one type of sensor from which to generate their respective output.

Device orientation analyzer 906 is configured to assess the overall orientation of the computing device. Device movement analyzer 908 is configured to assess the overall movement of the computing device. Device orientation analyzer 906 and device movement analyzer 908 may use information from such sensors as accelerometer, gyroscope, magnetometer, and the like, or any combination of these, to produce their respective output.

Touch gesture analyzer 910 is configured to interpret one or more inputs other than the hinge/flex movement to identify touch, or related, gestures, such as hand-signals. Inputs that may feed to touch gesture analyzer include touchscreen, a touch-sensitive bezel, and input from one or more peripheral devices such as a touchpad, mouse, wearable motion sensor, or camera, for example. User input analyzer 912 is configured to detect other user inputs such as button presses, for example.

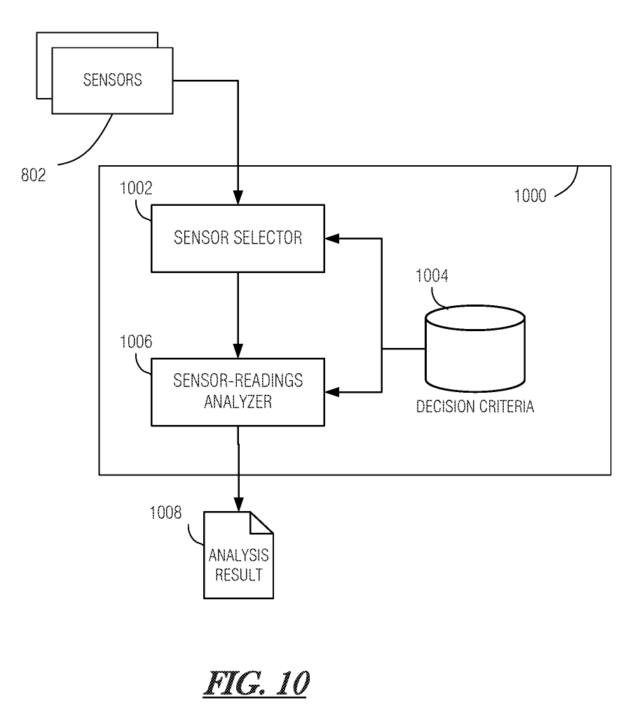

FIG. 10 is a system block diagram illustrating an example architecture 1000 of an engine of sensor analyzer engine 900 (of FIG. 9), such as hinge position analyzer engine 902, hinge/flex movement analyzer 904, etc. Sensor selector 1002 reads certain relevant sensors from the full set of available sensors based on decision criteria 1004. For example, sensor selector 1002 of hinge/flex movement analyzer 904 may select a hinge position sensor, a strain sensor in the panel, a motion sensor in one or more panels, etc., to be read, and from which combination the hinge/flex movement may be assessed.

Sensor-readings analyzer 1006 performs the relevant computation based on the relevant sensor readings, and on decision criteria 1004 specific to the analysis to be performed. For example, sensor-readings analyzer 1006 of hinge/flex movement analyzer 904 may read a hinge position sensor and assess the hinge movement based on a rate of change of the hinge position based on a series of positional measurements and the passage of time. Sensor-readings analyzer 1006 produces analysis result 1008 that represents the analyzed operational parameter.

Referring again to FIG. 9, situational determination engine 950 includes flex gesture determination engine 914, device posture determination engine 916, and usage experience determination 918. Flex gesture determination engine 914 obtains as its input the result of the operation of hinge position analyzer 902, the result produced by operation of hinge/flex movement analyzer 904, or both. Based on these input(s), and on flex-gesture criteria, flex gesture determination engine 914 detects and identifies gestures made using motion of a hinge or flexing of the display panels.

Device posture determination engine 916 reads as its inputs the outputs from hinge position analyzer 902, hinge/flex movement analyzer 904, device orientation analyzer 906, or device movement analyzer 908. Based on one, or a combination, of these inputs, and on device posture criteria, device posture determination engine 916 assesses the current posture of the computing device.

Usage experience determination engine 918 assesses various other circumstances relating to how the computing device is used. For instance, in one example embodiment, the device orientation, combined with the device posture, combined with the type of user input being obtained, is analyzed to infer how the user may be oriented and, ultimately, how the user is likely to expect or intuit certain flex gestures to control the computing device. To illustrate, consider an example first use case where the user may be in a recumbent position, a second use case where the user is in an upright seated position, and a third use case where the user is in motion (e.g. walking). In these various scenarios, a given flex gesture may be interpreted differently.

In the example depicted in FIG. 9, usage experience determination engine reads as its input the output of device posture determination engine 916, along with various other sensor-readings analysis results from device orientation analyzer 906, device movement analyzer 908, touch gesture analyzer 910, and user input analyzer 912.

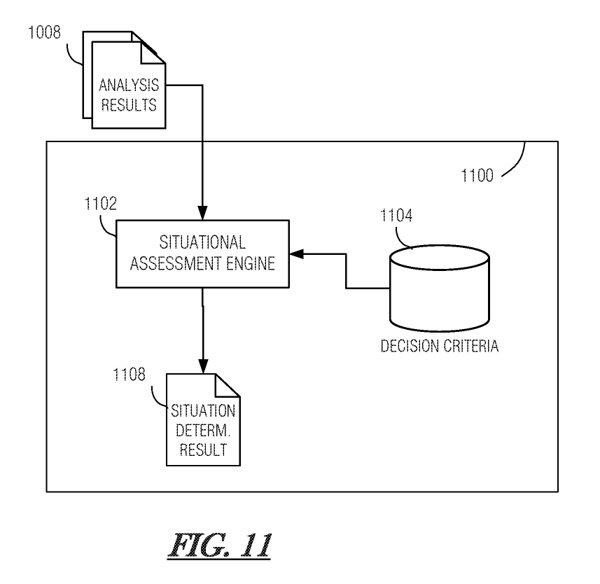

FIG. 11 is a system block diagram illustrating an example architecture 1100 of an engine that forms a part of situational determination engine 950 (of FIG. 9). Situational assessment engine 1102 reads analysis results 1008 from one or more of the engines that make up sensor analyzer engine 900 (of FIG. 9), and applies decision criteria 1104 to produce situation determination result 1108. Notably, touch gestures, device motion gestures, non-gesture device motion, and other user input, may all contribute to the usage experience determination.

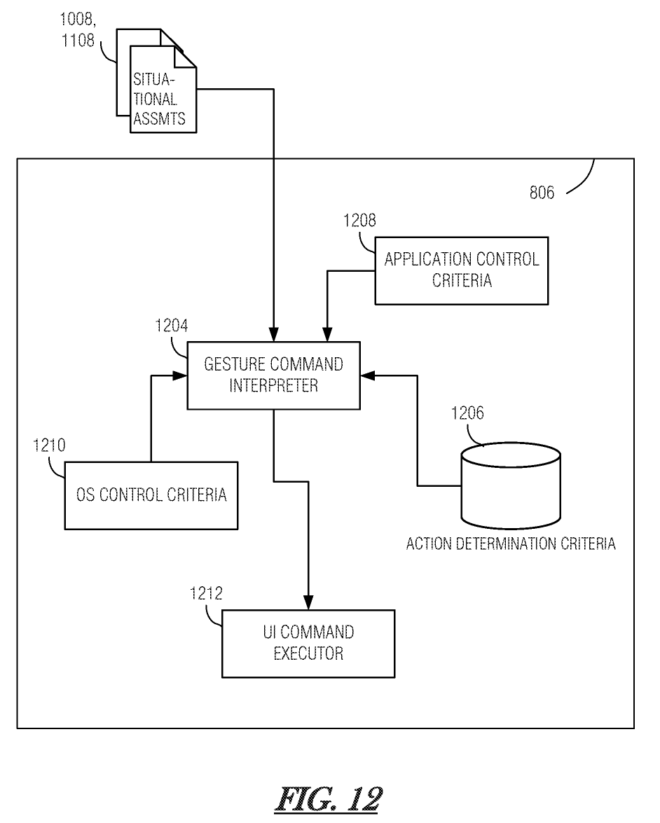

FIG. 12 is a system block diagram illustrating an example system architecture of UI output engine 806 according to an embodiment. As depicted, gesture command interpreter 1204 receives situational assessments 1008 and 1108 from situational analyzer 804. These include determined flex gestures, device posture information, and usage experience information, for example. These inputs are interpreted to determine an action or command to execute in response to the flex gesture. The determination is based on predefined action determination criteria 1206, along with application control criteria 1208 and OS control criteria 1210.

In one embodiment, action determination criteria is stored as a data structure, such as a list, array, relational database, or the like, that associates various combinations of flex gestures, device postures, and usage experiences, with commands or actions to be taken in response to the flex gesture. In a related embodiment, application control criteria 1208 may include specific actions or commands to be executed for specific applications. For instance, a flip gesture may normally advance a document to the next page, or scroll down to the next set of viewable content, but in certain applications, such as a Web browser, for example, a flip gesture may perform a “back” command. In this regard, application control criteria may supersede the action determination criteria 1206. Separately, OS control criteria 1210 may include other control criteria that may be hierarchically superior, or inferior, to application control criteria 1208, according to user-preference settings of the OS.

In another example, the flex gesturing may be augmented by touchscreen input activity, or by additional input activity, as detected by touch gesture analyzer 910 or user input analyzer 912 (of FIG. 9). In this case, there may be certain combinations of input represented in action determination criteria 1206 that are not specifically called out in either of application control criteria 1208, or OS control criteria 1210. In a related embodiment, gesture command interpreter 1204 is configured to not merely look up a specific combination of inputs from one source, but to combine criteria between action determination criteria 1206, application control criteria 1208, and OS control criteria 1210. For example, if a touchscreen long-press that accompanies a certain gesture is defined in action determination criteria 1206 as a gain-multiplier for a given gesture-initiated action, the same gain multiplication may be applied to an action called out by application control criteria 1208 for a given flex gesture, rather than the default action from action determination criteria 1206 for the same flex gesture.

Gesture command interpreter 1204 is configured ascertain an action (out of possibly several or more actions) to be performed in response to the flex gesture. An indication of the ascertained action is passed to UI command executor 1212. UI command executor 1212 is programmed, or otherwise configured, to carry out the action. In one embodiment, UI command executor 1212 is an engine that processes all user input of the computing device, including touch gestures, button presses, movement gestures, voice-recognized commands, etc. In another embodiment, UI command executor 1212 is specific to a subset of input types, such as gestures. In still another embodiment, UI command executor 1212 is specific to flex gesturing.

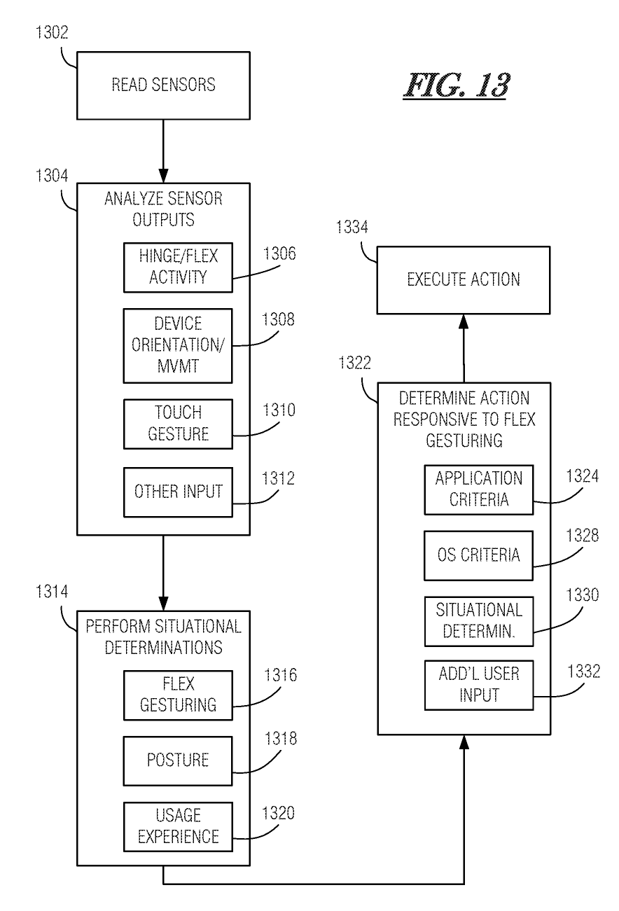

FIG. 13 is a flow diagram illustrating a set of example processing operations performed by a system, such as the systems of FIGS. 8-12, according to various embodiments. It is important to note that the example processes are richly-featured embodiments that may be realized as described; in addition, portions of the processes may be implemented while others are excluded in various embodiments. The following Additional Notes and Examples section details various combinations, without limitation, that are contemplated. It should also be noted that in various embodiments, certain process operations may be performed in a different ordering than depicted, provided that the logical flow and integrity of the process is not disrupted in substance.

At 1302, sensors 802 capture data and pass this data, or make it available to situational analyzer 804. At 1304, situational analyzer 804 analyzes the sensor outputs, including determining hinge motion or flexing activity at 1306, device orientation or movement at 1308, touch gestures at 1310, and other input at 1312. At 1314, situational analyzer 804 computes situational determinations, including determining flex gesturing at 1316, the current device posture at 318, and usage experience at 1320. At 1322, UI output engine 806 determines the action or command to execute in response to the flex gesturing. This is based on reading the application criteria at 1324, the OS criteria at 1328, the situational determination at 1330, and any additional user input at 1332.

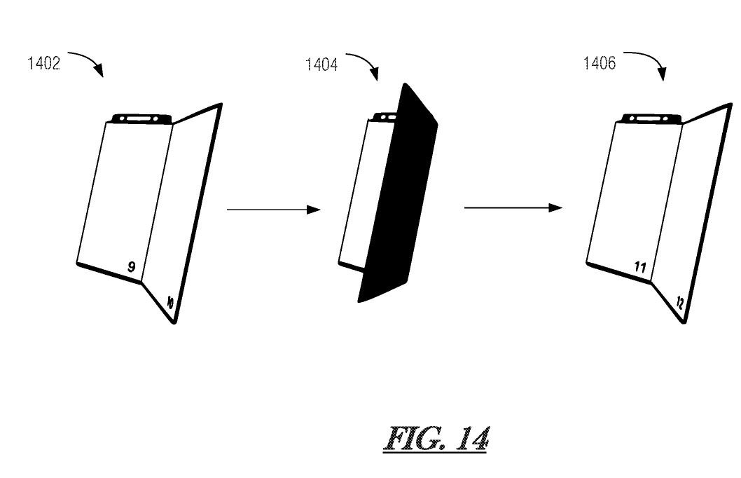

FIG. 14 is an illustrative example of the operations of FIG. 13. At 1402, a flexible computing device is being used to display multi-page content. As depicted, pages 9 and 10 are displayed respectively, on the left and right panels of the computing device. At 1404 and 1406, a flip gesture is performed. Accordingly, at 1404 the panels are brought together to some extent, immediately followed by returning the panels to their initial position. The sensors are read throughout this gesture, and capture a series of hinge positions as a function of time. Also, the general orientation and movement or stationarity of the computing device are sensed. The sensor outputs indicating the hinge position are analyzed at 1306, and the device orientation and movement are analyzed at 1308. In this example, no other input is provided, although in other embodiments additional inputs, such as touch gesturing, for instance, may be taken into account. The result of these analyses in the present example is a recognition of a deliberate movement of the hinged panels of the computing device.

Referring again to FIG. 13, at 1316, the movement and timing of the deliberate movement of the hinged panels is compared against gesture-recognition criteria relating to the angular velocity of the movement, and the timing of the inward and outward motions, for example. If the measured hinge movement is within defined limits for the gesture recognition, the movement is recognized as a flip gesture. At 1322, the flip gesture, now recognized as such, is taken into account with other measured situational circumstances, such as the document-reader application, device orientation, device movement, and the like. The relevant criteria for action assessment is applied, including checking whether there are specific criteria in the active application and then checking whether there are any specific criteria of the OS and, if no specific criteria is applicable, then using the default decision criteria. In the depicted example, the result of these operations is a determination that the action to be performed in response to the flip gesture is advancing the display to the next viewable section of the document. Accordingly, at 1334 UI command executor 1212 of UI output engine 806 advances the displayed pages to pages 11 and 12 (as illustrated in FIG. 14).

### ADDITIONAL NOTES & EXAMPLES

Example 1 is a system for processing flex gesturing in a computing device that includes a plurality of display panels movable in relation to one another, the system comprising: a sensor analyzer to assess flex movement of a first display panel as detected by at least one flex sensor of the computing device; a situational determination engine to: interpret the flex movement according to predefined criteria to recognize a flex gesture; and determine a current device posture, the device posture being defined by a relative positioning of the display panels; a gesture command interpreter to ascertain an action, from among a plurality of possible actions associated with the flex gesture to be performed, in response to the flex gesture, and based further on the current device posture; and a user interface command executor to carry out the action.

In Example 2, the subject matter of Example 1 optionally includes a flex sensor operatively coupled with the sensor analyzer, the flex sensor being arranged to measure the flex movement.

In Example 3, the subject matter of Example 2 optionally includes a hinge adjoining at least two of the display panels, including the first display panel, wherein the flex sensor is arranged to measure a position of the hinge.

In Example 4, the subject matter of any one or more of Examples 2-3 optionally include a hinge adjoining at least two of the display panels including the first display panel, wherein the flex sensor is arranged to measure motion of the hinge.

In Example 5, the subject matter of any one or more of Examples 2-4 optionally include a hinge adjoining at least two of the display panels, including the first display panel, wherein the flex sensor is arranged to measure deformation of the hinge.

In Example 6, the subject matter of any one or more of Examples 2-5 optionally include wherein the flex sensor is arranged to detect deformation of at least one of the display panels.

In Example 7, the subject matter of any one or more of Examples 1-6 optionally include wherein the first display panel is flexible, and wherein the flex movement includes deformation of the first display panel.

In Example 8, the subject matter of any one or more of Examples 1-7 optionally include wherein the gesture command interpreter is to ascertain the action to be performed in response to the flex gesture and based further on a usage experience determination that includes at least one measured parameter selected from among the group consisting of: device orientation, device motion, user input via an input device, or any combination thereof.

In Example 9, the subject matter of any one or more of Examples 1-8 optionally include wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

In Example 10, the subject matter of any one or more of Examples 1-9 optionally include wherein the predefined criteria to recognize the flex gesture includes criteria to recognize a pour gesture in which the first display panel is partially folded inward from an initial position, and maintained in an inward-folded position for at least a predefined time duration.

In Example 11, the subject matter of Example 10 optionally includes wherein in response to the pour gesture, the gesture command interpreter is to ascertain an action to be performed that includes gradual application of a variable-degree control input corresponding to a time duration of invocation of the pour gesture.

In Example 12, the subject matter of any one or more of Examples 1-11 optionally include wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

In Example 13, the subject matter of any one or more of Examples 1-12 optionally include wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.

In Example 14, the subject matter of any one or more of Examples 1-13 optionally include a hinge adjoining at least two of the display panels including the first display panel; and a flexible display device spanning the at least two display panels, wherein flexing of the hinge causes flexing of the flexible display panel at the position of the hinge.

In Example 15, the subject matter of any one or more of Examples 1-14 optionally include a hinge adjoining at least two of the display panels including the first display panel; and at least two display devices, each situated on a corresponding one of the at least two display panels, wherein flexing of the hinge is independent from any flexing of the at least two display panels.

In Example 16, the subject matter of any one or more of Examples 1-15 optionally include computing circuitry including a processor, memory and input/output facilities, the memory containing instructions that, when executed by the processor, cause the computing circuitry to implement the sensor analyzer, the situational determination engine, and the gesture command interpreter.

Example 17 is a machine-readable medium comprising instructions that, when executed on a processor of a computing device having a plurality of display panels movable in relation to one another, causes the computing device to: assess flex movement of a first display panel as detected by at least one flex sensor of the computing device; interpret the flex movement according to predefined criteria to recognize a flex gesture; determine a current device posture, the device posture being defined by a relative positioning of the display panels; ascertain an action, from among a plurality of possible actions associated with the flex gesture to be performed, in response to the flex gesture, and based further on the current device posture; and execute the action.

In Example 18, the subject matter of Example 17 optionally includes instructions that, when executed on the processor of the computing device, cause the computing device to measure deformation of the display panels as a type of the flex movement.

In Example 19, the subject matter of any one or more of Examples 17-18 optionally include instructions that, when executed on the processor of the computing device, cause the computing device to measure a position of a hinge adjoining panels of the computing device as a type of the flex movement.

In Example 20, the subject matter of any one or more of Examples 17-19 optionally include instructions that, when executed on the processor of the computing device, cause the computing device to measure motion of a hinge adjoining panels of the computing device as a type of the flex movement.

In Example 21, the subject matter of any one or more of Examples 17-20 optionally include instructions that, when executed on the processor of the computing device, cause the computing device to measure deformation of a hinge adjoining panels of the computing device as a type of the flex movement.

In Example 22, the subject matter of any one or more of Examples 17-21 optionally include wherein the instructions to ascertain the action to be performed in response to the flex gesture are further to ascertain the action to be performed on a usage experience determination that includes at least one measured parameter selected from among the group consisting of: device orientation, device motion, user input via an input device, or any combination thereof.

In Example 23, the subject matter of any one or more of Examples 17-22 optionally include wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

In Example 24, the subject matter of any one or more of Examples 17-23 optionally include wherein the predefined criteria to recognize the flex gesture includes criteria to recognize a pour gesture in which the first display panel is partially folded inward from an initial position, and maintained in an inward-folded position for at least a predefined time duration.

In Example 25, the subject matter of Example 24 optionally includes wherein in response to the pour gesture, the instructions to ascertain the action to be performed includes instructions to gradually apply a variable-degree control input corresponding to a time duration of invocation of the pour gesture.

In Example 26, the subject matter of any one or more of Examples 17-25 optionally include wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

In Example 27, the subject matter of any one or more of Examples 17-26 optionally include wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.

Example 28 is apparatus for applying flex gesturing in a computing device having a plurality of display panels movable in relation to one another, the apparatus comprising: means for assessing flex movement of a first display panel as detected by at least one flex sensor of the computing device; means for interpreting the flex movement according to predefined criteria to recognize a flex gesture; means for determining a current device posture, the device posture being defined by a relative positioning of the display panels; means for ascertaining an action, from among a plurality of possible actions associated with the flex gesture to be performed, in response to the flex gesture, and based further on the current device posture; and means for executing the action.

In Example 29, the subject matter of Example 28 optionally includes means for measuring deformation of the display panels as a type of the flex movement.

In Example 30, the subject matter of any one or more of Examples 28-29 optionally include means for measuring a position of a hinge adjoining panels of the computing device as a type of the flex movement.

In Example 31, the subject matter of any one or more of Examples 28-30 optionally include means for measuring motion of a hinge adjoining panels of the computing device as a type of the flex movement.

In Example 32, the subject matter of any one or more of Examples 28-31 optionally include means for measuring deformation of a hinge adjoining panels of the computing device as a type of the flex movement.

In Example 33, the subject matter of any one or more of Examples 28-32 optionally include wherein the means for ascertaining the action to be performed in response to the flex gesture includes means for ascertaining the action to be performed on a usage experience determination that includes at least one measured parameter selected from among the group consisting of: device orientation, device motion, user input via an input device, or any combination thereof.

In Example 34, the subject matter of any one or more of Examples 28-33 optionally include wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

In Example 35, the subject matter of any one or more of Examples 28-34 optionally include wherein the predefined criteria to recognize the flex gesture includes criteria to recognize a pour gesture in which the first display panel is partially folded inward from an initial position, and maintained in an inward-folded position for at least a predefined time duration.

In Example 36, the subject matter of Example 35 optionally includes wherein the means for ascertaining the action to be performed includes means for applying a variable-degree control input corresponding to a time duration of invocation of the pour gesture.

In Example 37, the subject matter of any one or more of Examples 28-36 optionally include wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

In Example 38, the subject matter of any one or more of Examples 28-37 optionally include wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.

Example 39 is a method for applying flex gesturing in a computing device having a plurality of display panels movable in relation to one another, the method comprising: assessing, by the computing device, flex movement of a first display panel as detected by at least one flex sensor of the computing device; interpreting, by the computing device, the flex movement according to predefined criteria to recognize a flex gesture; determining, by the computing device, a current device posture, the device posture being defined by a relative positioning of the display panels; ascertaining, by the computing device, an action, from among a plurality of possible actions associated with the flex gesture to be performed, in response to the flex gesture, and based further on the current device posture; and executing the action by the computing device.

In Example 40, the subject matter of Example 39 optionally includes measuring, by the computing device, deformation of the display panels as a type of the flex movement.

In Example 41, the subject matter of any one or more of Examples 39-40 optionally include measuring, by the computing device, a position of a hinge adjoining panels of the computing device as a type of the flex movement.

In Example 42, the subject matter of any one or more of Examples 39-41 optionally include measuring, by the computing device, motion of a hinge adjoining panels of the computing device as a type of the flex movement.

In Example 43, the subject matter of any one or more of Examples 39-42 optionally include measuring, by the computing device, deformation of a hinge adjoining panels of the computing device as a type of the flex movement.

In Example 44, the subject matter of any one or more of Examples 39-43 optionally include wherein ascertaining the action to be performed in response to the flex gesture includes ascertaining the action to be performed on a usage experience determination that includes at least one measured parameter selected from among the group consisting of: device orientation, device motion, user input via an input device, or any combination thereof.

In Example 45, the subject matter of any one or more of Examples 39-44 optionally include wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

In Example 46, the subject matter of any one or more of Examples 39-45 optionally include wherein the predefined criteria to recognize the flex gesture includes criteria to recognize a pour gesture in which the first display panel is partially folded inward from an initial position, and maintained in an inward-folded position for at least a predefined time duration.

In Example 47, the subject matter of Example 46 optionally includes wherein ascertaining the action to be performed includes applying a variable-degree control input corresponding to a time duration of invocation of the pour gesture.

In Example 48, the subject matter of any one or more of Examples 39-47 optionally include wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

In Example 49, the subject matter of any one or more of Examples 39-48 optionally include wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.

Example 50 is a system for applying flex gesturing in a computing device having a plurality of display panels movable in relation to one another, the system comprising means for carrying out the method according to any one of Examples 39-49.

Example 51 is a computer-readable medium comprising instructions that, when executed by a computing device having a plurality of display panels movable in relation to one another, cause the computing device to carry out the method according to any one of Examples 39-49.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for processing flex gesturing in a computing device that includes a plurality of display panels movable in relation to one another, the system comprising:
a sensor analyzer to assess flex movement of a first display panel as detected by at least one flex sensor of the computing device;
a situational determination engine to:
interpret the flex movement according to predefined criteria to recognize a flex gesture; and
determine a current device posture, the device posture being defined by a relative positioning of the display panels;
a gesture command interpreter to ascertain an action, from among a plurality of possible actions associated with the flex gesture to be performed, in response to the flex gesture, and based further on the current device posture; and
a user interface command executor to carry out the action.

2. The system of claim 1, further comprising:
a flex sensor operatively coupled with the sensor analyzer, the flex sensor being arranged to measure the flex movement.

3. The system of claim 2, further comprising:
a hinge adjoining at least two of the display panels, including the first display panel, wherein the flex sensor is arranged to measure a position of the hinge.

4. The system of claim 2, further comprising:
a hinge adjoining at least two of the display panels including the first display panel, wherein the flex sensor is arranged to measure motion of the hinge.

5. The system of claim 2, further comprising:
a hinge adjoining at least two of the display panels, including the first display panel, wherein the flex sensor is arranged to measure deformation of the hinge.

6. The system of claim 2, wherein the flex sensor is arranged to detect deformation of at least one of the display panels.

7. The system of claim 1, wherein the first display panel is flexible, and wherein the flex movement includes deformation of the first display panel.

8. The system of claim 1, wherein the gesture command interpreter is to ascertain the action to be performed in response to the flex gesture and based further on a usage experience determination that includes at least one measured parameter selected from among the group consisting of: device orientation, device motion, user input via an input device, or any combination thereof.

9. The system of claim 1, wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

10. The system of claim 1, wherein the predefined criteria to recognize the flex gesture includes criteria to recognize a pour gesture in which the first display panel is partially folded inward from an initial position, and maintained in an inward-folded position for at least a predefined time duration.

11. The system of claim 10, wherein in response to the pour gesture, the gesture command interpreter is to ascertain an action to be performed that includes gradual application of a variable-degree control input corresponding to a time duration of invocation of the pour gesture.

12. The system of claim 1, wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

13. The system of claim 1, wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.

14. The system of claim 1, further comprising:
a hinge adjoining at least two of the display panels including the first display panel; and
a flexible display device spanning the at least two display panels, wherein flexing of the hinge causes flexing of the flexible display panel at the position of the hinge.

15. The system of claim 1, further comprising:
a hinge adjoining at least two of the display panels including the first display panel; and
at least two display devices, each situated on a corresponding one of the at least two display panels, wherein flexing of the hinge is independent from any flexing of the at least two display panels.

16. The system of claim 1, further comprising:
computing circuitry including a processor, memory and input/output facilities, the memory containing instructions that, when executed by the processor, cause the computing circuitry to implement the sensor analyzer, the situational determination engine, and the gesture command interpreter.

17. At least one machine-readable medium comprising instructions that, when executed on a processor of a computing device having a plurality of display panels movable in relation to one another, causes the computing device to:
assess flex movement of a first display panel as detected by at least one flex sensor of the computing device;
interpret the flex movement according to predefined criteria to recognize a flex gesture;
determine a current device posture, the device posture being defined by a relative positioning of the display panels;
ascertain an action, from among a plurality of possible actions associated with the flex gesture to be performed, in response to the flex gesture, and based further on the current device posture; and
execute the action.

18. The machine-readable medium of claim 17, wherein the instructions to ascertain the action to be performed in response to the flex gesture are further to ascertain the action to be performed on a usage experience determination that includes at least one measured parameter selected from among the group consisting of: device orientation, device motion, user input via an input device, or any combination thereof.

19. The machine-readable medium of claim 17, wherein the predefined criteria to recognize the flex gesture includes criteria to recognize a flip gesture in which the first display panel is partially folded inward from an initial position by a first movement, then returned to the initial position by a second movement, wherein the first movement and the second movement occur within a defined time window.

20. The machine-readable medium of claim 17, wherein the predefined criteria to recognize the flex gesture includes criteria to recognize a pour gesture in which the first display panel is partially folded inward from an initial position, and maintained in an inward-folded position for at least a predefined time duration.

21. A method for applying flex gesturing in a computing device having a plurality of display panels movable in relation to one another, the method comprising:
assessing, by the computing device, flex movement of a first display panel as detected by at least one flex sensor of the computing device;
interpreting, by the computing device, the flex movement according to predefined criteria to recognize a flex gesture;
determining, by the computing device, a current device posture, the device posture being defined by a relative positioning of the display panels;
ascertaining, by the computing device, an action, from among a plurality of possible actions associated with the flex gesture to be performed, in response to the flex gesture, and based further on the current device posture; and
executing the action by the computing device.

22. The method of claim 21, wherein the predefined criteria to recognize the flex gesture includes criteria to recognize a pour gesture in which the first display panel is partially folded inward from an initial position, and maintained in an inward-folded position for at least a predefined time duration.

23. The method of claim 22, wherein ascertaining the action to be performed includes applying a variable-degree control input corresponding to a time duration of invocation of the pour gesture.

24. The method of claim 21, wherein the predefined criteria to recognize the flex gesture includes criteria to recognize a fold gesture in which the first display panel is pivoted so that a display device of the first display panel faces outward while the back side of the first display panel is positioned against another one of the display panels, and maintained in that position for at least a predefined time duration.

25. The method of claim 21, wherein the predefined criteria to recognize the flex gesture includes criteria to recognize a stamp gesture in which the first display panel is pivoted from an initial position toward another panel, with displays of those panels facing one another until those displays are within a defined proximity, then the first display panel is pivoted back towards its initial position.
